(19) United States
(12) Patent Application Publication
(10) Pub. No.: US 2023/0079589 A1
(43) Pub. Date: Mar. 16, 2023

(54) HEATER DEVICE FOR A DRYING SYSTEM

(71) Applicant: NETZRO, SBC, Minneaplis, MN (US)

(72) Inventors: Garrick M. Villaume, St. Paul, MN (US); Stanley Lester Davis, II, Minneapolis, MN (US); Paul Douglas Rudd, Minneapolis, MN (US)

(21) Appl. No.: 17/472,281

(22) Filed: Sep. 10, 2021

(51) Int. Cl. F26B 3/30; F26B 23/04; F26B 25/08

(52) U.S. Cl. CPC F26B 3/30; F26B 23/04; F26B 25/08

(57) ABSTRACT

Disclosed herein is technology related to a heater device and corresponding systems and method. In examples the heater device has a frame having a base structure and a support beam. The support beam extends upward from the base structure. The frame is translatable across a ground surface. A cantilevered elongate heater extends from the frame. The elongate heater has a proximal end and a distal end, where the proximal end is coupled to the support beam of the frame. In some examples the elongate heater has a first heater element rotatable about an elongate axis central to the elongate heater. Additionally or alternatively, a plurality of heater elements are coupled to the cantilevered beam.

### TECHNOLOGICAL FIELD

The current technology generally relates to a heater device. More particularly, the current technology relates to a heater device for a drying system.

### SUMMARY

Some embodiments of the technology disclosed herein relate to a heater device having a frame having a base structure and a support beam extending upward from the base structure. The frame is translatable across a ground surface. A cantilevered elongate heater extends from the frame. The elongate heater having a proximal end and a distal end, where the proximal end is coupled to the support beam of the frame. The elongate heater has a first heater element rotatable about an elongate axis central to the elongate heater.

In some such embodiments, the elongate heater has a modifiable vertical position relative to the base structure of the frame. Additionally or alternatively, the elongate heater forms an adjustable angle with the support beam. Additionally or alternatively, the elongate heater has a plurality of heater elements disposed across the elongate heater, where the plurality of heater elements comprises the first heater element. In some such embodiments, the plurality of heater elements include infrared heater elements. Additionally or alternatively, a blower is mounted to the frame, where the blower is in airflow communication with the elongate heater. In some such embodiments, flexible tubing extends from the blower to the elongate heater. Additionally or alternatively, the elongate heater is configured to be tilted up to 15 degrees from horizontal. Additionally or alternatively, the elongate heater has a cantilevered beam that is rotatable about the elongate axis. Additionally or alternatively, each of the plurality of heater elements are independently rotatable about the elongate axis.

Some other embodiments relate to a heater device having a frame having a base structure and a support beam extending upward from the base structure, The frame is translatable across a ground surface. A cantilevered elongate heater extends from the frame and has a proximal end and a distal end, where the proximal end is coupled to the support beam of the frame. The elongate heater has a cantilevered beam having an elongate central axis. A plurality of heater elements are coupled to the cantilevered beam.

In some such embodiments, the elongate heater has a modifiable vertical position relative to the base structure of the frame. Additionally or alternatively, the elongate heater forms an adjustable angle with the support beam. Additionally or alternatively, each of the plurality of heater elements has a different orientation relative to the elongate central axis than an adjacent heater element. Additionally or alternatively, the orientation of each of the plurality of heater elements is fixed relative to the cantilevered beam. Additionally or alternatively, each of the plurality of heater elements are independently rotatable about the elongate axis. Additionally or alternatively, the cantilevered beam is rotatable about the elongate axis. Additionally or alternatively, a blower is mounted to the frame, where the blower is in airflow communication with the elongate heater. Additionally or alternatively, flexible tubing extends from the blower to the elongate heater. Additionally or alternatively, the elongate heater is configured to be tilted up to 15 degrees from horizontal.

Some other embodiments relate to a system. The system has a vessel having a vessel central axis, a first end, and a second end. The vessel forms a vessel cavity extending from the first end through the second end about the vessel central axis. A heater device has a frame and a cantilevered elongate heater extending from the frame. The elongate heater is selectively insertable into the vessel cavity and removable from the vessel cavity. The elongate heater has an elongate axis that is adjustable relative to the vessel central axis.

In some such embodiments, the elongate heater has a modifiable vertical position relative to the frame. Additionally or alternatively, the elongate heater forms an adjustable angle with the frame. Additionally or alternatively, the elongate heater has a plurality of heater elements disposed across the elongate heater. Additionally or alternatively, the plurality of heater elements has infrared heater elements. Additionally or alternatively, the system has a blower mounted to the frame, where the blower is in airflow communication with the elongate heater. Additionally or alternatively, a flexible tube extends from the blower to the elongate heater. Additionally or alternatively, the elongate heater is configured to be tilted up to 15 degrees from horizontal. Additionally or alternatively, each of the plurality of heater elements are independently rotatable about an elongate axis central to the elongate heater. Additionally or alternatively, the elongate heater is rotatable about an elongate axis central to the elongate heater.

Some embodiments of the current technology relate to a method of treating a byproduct. The byproduct is loaded into a vessel cavity of a vessel. The vessel is rotated about a central vessel axis. An elongate heater of a heater device is inserted into a vessel cavity of the vessel. Heat is radiated at an intensity from the elongate heater into the vessel cavity. And the intensity of the heat radiating from the elongate heater is changed.

In some such embodiments, an elongate axis of the elongate heater is adjusted relative to the vessel central axis. In some such embodiments, adjusting the elongate axis includes tilting the elongate axis relative to the vessel central axis. Additionally or alternatively, adjusting the elongate axis includes translating the elongate axis vertically relative to the vessel central axis. Additionally or alternatively, the heater device is an infrared heater device. Additionally or alternatively, the byproduct includes grain. Additionally or alternatively, the byproduct includes eggshells.

The above summary is not intended to describe each embodiment or every implementation. Rather, a more complete understanding of illustrative embodiments will become apparent and appreciated by reference to the following Detailed Description and claims in view of the accompanying figures of the drawing.

### BRIEF DESCRIPTION OF THE DRAWINGS

The present technology may be more completely understood and appreciated in consideration of the following detailed description of various embodiments in connection with the accompanying drawings.

FIG. 1A depicts a first perspective view of an example heater device consistent with the technology disclosed herein.

FIG. 1B depicts a second perspective view of another example heater device consistent with various embodiments.

FIG. 2 depicts a first facing view of an example heater device consistent with FIG. 1A.

FIG. 3 depicts a partial cross-sectional facing view of another example heater device consistent with embodiments.

FIG. 4 depicts a perspective view of a system for treating byproducts consistent with the technology disclosed herein.

FIG. 5 depicts a first view of the system of FIG. 4.

FIG. 6 depicts a perspective view of another example heater device consistent with various embodiments.

The figures are rendered primarily for clarity and, as a result, are not necessarily drawn to scale. Moreover, various structure/components, including but not limited to fasteners, electrical components (wiring, cables, etc.), and the like, may be shown diagrammatically or removed from some or all of the views to better illustrate aspects of the depicted embodiments, or where inclusion of such structure/components is not necessary to an understanding of the various exemplary embodiments described herein. The lack of illustration/description of such structure/components in a particular figure is, however, not to be interpreted as limiting the scope of the various embodiments in any way.

### DETAILED DESCRIPTION

### Exemplary Embodiments of Heater Devices

Embodiment 1. A heater device comprising:
a frame having a base structure and a support beam extending upward from the base structure, wherein the frame is translatable across a ground surface; and
a cantilevered elongate heater extending from the frame, the elongate heater having a proximal end and a distal end, wherein the proximal end is coupled to the support beam of the frame, and wherein the elongate heater comprises a first heater element rotatable about an elongate axis central to the elongate heater.
Embodiment 2. The heater device of any one of embodiments 1 and 3-10, wherein the elongate heater has a modifiable vertical position relative to the base structure of the frame.
Embodiment 3. The heater device of any one of embodiments 1-2 and 4-10, wherein the elongate heater forms an adjustable angle with the support beam.
Embodiment 4. The heater device of any one of embodiments 1-3 and 6-10, wherein the elongate heater comprises a plurality of heater elements disposed across the elongate heater, wherein the plurality of heater elements comprises the first heater element.
Embodiment 5. The heater device of embodiment 4, wherein the plurality of heater elements comprises infrared heater elements.
Embodiment 6. The heater device of any one of embodiments 1-5 and 7-10, further comprising a blower mounted to the frame, wherein the blower is in airflow communication with the elongate heater.
Embodiment 7. The heater device of embodiment 6, further comprising flexible tubing extending from the blower to the elongate heater.
Embodiment 8. The heater device of any one of embodiments 1-7 and 9-10 wherein the elongate heater is configured to be tilted up to 15 degrees from horizontal.
Embodiment 9. The heater device of any one of embodiments 1-8 and 10, wherein the elongate heater comprises a cantilevered beam that is rotatable about the elongate axis.
Embodiment 10. The heater device of any one of embodiments 4-5, wherein each of the plurality of heater elements are independently rotatable about the elongate axis.
Embodiment 11. A heater device comprising:
a frame having a base structure and a support beam extending upward from the base structure, wherein the frame is translatable across a ground surface; and
a cantilevered elongate heater extending from the frame, the elongate heater having a proximal end and a distal end, wherein the proximal end is coupled to the support beam of the frame, and wherein the elongate heater comprises a cantilevered beam having an elongate central axis and a plurality of heater elements coupled to the cantilevered beam.
Embodiment 12. The heater device of any one of embodiments 11 and 13-20, wherein the elongate heater has a modifiable vertical position relative to the base structure of the frame.
Embodiment 13. The heater device of any one of embodiments 11-12 and 14-20, wherein the elongate heater forms an adjustable angle with the support beam.
Embodiment 14. The heater device of any one of embodiments 11-13 and 15-20, wherein each of the plurality of heater elements has a different orientation relative to the elongate central axis than an adjacent heater element.
Embodiment 15. The heater device of any one of embodiments 11-14 and 16-20, wherein the orientation of each of the plurality of heater elements is fixed relative to the cantilevered beam.
Embodiment 16. The heater device of any one of embodiments 11-15 and 17-20, wherein each of the plurality of heater elements are independently rotatable about the elongate axis.
Embodiment 17. The heater device of any one of embodiments 11-16 and 18-20, wherein the cantilevered beam is rotatable about the elongate axis.
Embodiment 18. The heater device of any one of embodiments 11-17 and 19-20, further comprising a blower mounted to the frame, wherein the blower is in airflow communication with the elongate heater.
Embodiment 19. The heater device of any one of embodiments 11-18 and 20, further comprising flexible tubing extending from the blower to the elongate heater.
Embodiment 20. The heater device of any one of embodiments 11-19, wherein the elongate heater is configured to be tilted up to 15 degrees from horizontal.

### Specific Example Heater Devices

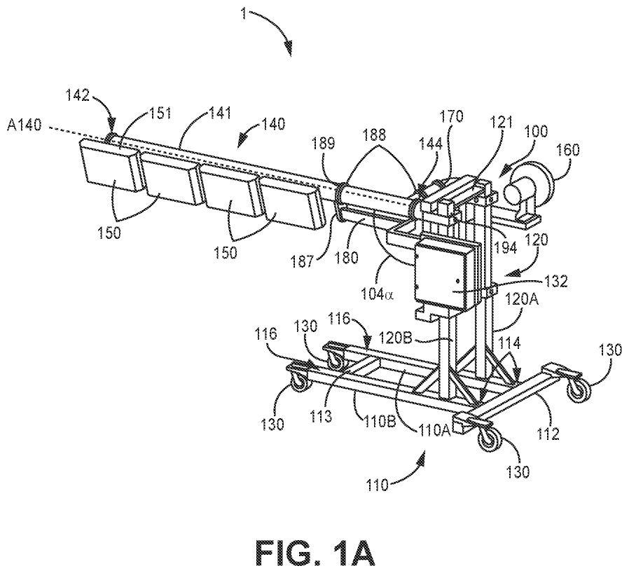

FIG. 1A and FIG. 1B depict a first and second perspective view, respectively, of example heater devices 1 consistent with the technology disclosed herein, where the same elements numbers denote similar elements. The heater device 1 generally has a frame 100 and an elongate heater 140 having a first heater element 151. The frame 100 is generally configured to support the elongate heater 140. The frame 100 is configured to provide stability to the elongate heater 140 and maintain the elongate heater 140 in its selected position. In various embodiments, the frame 100 is translatable across a ground surface 10 (visible in FIG. 1B). The frame 100 can have a variety of configurations. In the current example, the frame 100 generally has a base structure 110 and a support beam 120 coupled to the base structure.

The base structure 110 is generally configured to support various components of the heater device 1 on a surface, such as the ground surface 10 (FIG. 1B). More particularly, the base structure 110 can be configured to support and stabilize the elongate heater 140 and the support beam 120. The base structure 110 of the frame 100 can be particularly configured to allow translation of the heater device 1 across the ground surface 10. In various embodiments, the base structure 110 is configured to provide stability to the various components of the heater device 1 such as to prevent tipping of the heater device 1.

In the current example, the base structure 110 has a plurality of wheels 130 allowing translation of the heater device 1 across the ground surface 10. The wheels 130 can be coupled to the heater device 1 using approaches known in the art. The wheels 130 can be constructed from a variety of materials and combinations of materials known in the art. In some embodiments, one or more of the wheels 130 is a lockable, swivel caster wheel. In some embodiments one or more of the wheels 130 is a lockable rigid caster wheel. In such embodiments the frame 100 can have two operational modes where the frame 100 is selectively translatable across the ground surface (when one or more of the wheels are unlocked) and selectively stationary on the ground surface (when one or more of the wheels are locked). In some embodiments, one or more of the wheels is a not lockable. In some embodiments, components other that wheels can be implemented to allow translation of the frame across the ground surface such as rotating belts, sliding track systems, and the like.

The support beam 120 is generally configured to support the elongate heater 140 on the base structure 110. The support beam 120 extends upward from the base structure 110. The support beam 120 is generally fixed to the base structure 110. In some embodiments, the support beam 120 can be coupled to the base structure 110 using methods known in the art. For example, the support beam 120 can be coupled to the base structure 110 through fasteners such as screws, rivets, bolts, and the like. In some embodiments, the support beam 120 is integral with the base structure 110 such as through welding, molding, machining, or the like. The support beam 120 can be manufactured from a variety of materials and combinations of materials including but not limited to metal and plastic. In various embodiments, the support beam 120 is constructed of food grade materials suitable for use in processing of materials for eventual consumption. In some embodiments, the support beam 120 is constructed of a metal consistent with the NSF/ANSI 2 food equipment standard. In examples the support beam 120 is constructed of stainless steel.

In the exemplary embodiment depicted in FIG. 1A and FIG. 1B, the configuration of frame 100 has a base structure 110 that includes two primary base beams 110A, 110B. The primary base beams 110A, 110B have a distal end 116 and a proximal end 114. The primary base beams 110A, 110B are coupled to each other at the proximal end 114 via a primary base crossbeam 112. The primary base crossbeam 112 extends perpendicularly to the primary base beams 110A, 110B. In the current example, the primary base crossbeam 112 has a length that is greater than the distance between the primary base beam 110A, 110B. This configuration may advantageously provide enhanced stabilization of the base structure 110 and the frame 100. The primary base beams 110A, 110B are coupled towards their distal ends 116 via a secondary base crossbeam 113. In some embodiments, the base structure 110 has a distal end 116 that extends a sufficient distance from the proximal end 114 to counterbalance the moment on the frame 100 caused by the weight of the elongate heater 140. The base structure 110 can have a distal end 116 that extends a sufficient distance from the proximal end 114 to define a center of gravity of the heater device 1 that is positioned in vertical alignment with the base structure 110.

In the current example, two wheels 130 of the plurality of wheels 130 are each coupled to the primary base crossbeam 112. In the current example, the two wheels 130 are each coupled to opposite elongate ends of the primary base crossbeam 112. Two other wheels 130 of the plurality of wheels 130 are each coupled towards the distal end 116 of a corresponding primary base beam 110A, 110B. Other configurations of the wheels 130 on the base structure 110 are also possible.

In the exemplary embodiment depicted in FIG. 1A and FIG. 1B, the configuration of the support beam 120 of the frame 100 includes a first primary support beam 120A and a second primary support beam 120B. The primary support beams 120A, 120B extend upward from the base structure 110, and more particularly in this example, from primary base beams 110A, 110B, respectively. In the exemplary embodiment, each primary support beam 120A, 120B is fixed to a corresponding primary base beam 110A, 110B towards a proximal end 114 of the corresponding primary base beam 110A, 110B. In some other embodiments, the support beam 120 can be fixed to the base structure 110 in a different position along the primary base beam 110A, 110B, such as towards the center or towards the distal end 116 of each primary base beam 110A, 110B. In some such embodiments it may be desirable to have a counterweight disposed on the base structure 110 to counterbalance a moment or other force on the heater device 1 that may otherwise result in instability. In some embodiments, one or more crossbeams 121 extend between the primary support beams 120A, 120B. In this configuration, one end of a crossbeam 121 is fixed to the first primary support beam 120A, and the other end is fixed to the second primary support beam 120B. This configuration may provide enhanced stability of the support beam 120 and the base structure 110.

The elongate heater 140 extends outward from the frame 100 and is generally configured to produce and radiate heat along an elongate axis A140 and outwardly from the elongate axis. “Radiate” is defined herein as the discharge of energy, usually in the form of rays or waves. The elongate heater 140 is configured to extend generally horizontally outward from the support beam 120, although not necessarily perfectly horizontally (as will be described below, in some embodiments the elongate heater 140 can be tilted relative to the frame 100). The elongate heater 140 has a proximal end 144 and a distal end 142. The proximal end 144 is positioned towards the support beam 120. In particular, the proximal end 144 of the elongate heater 140 is coupled to the support beam 120.

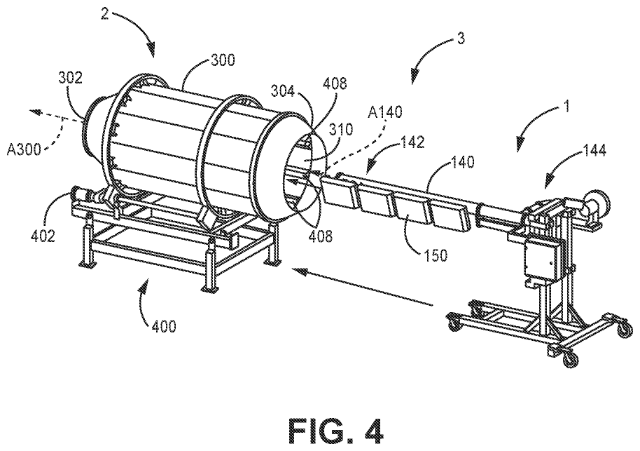

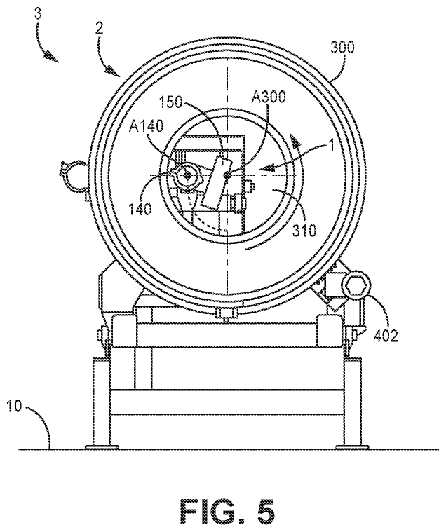

The elongate heater 140 generally has a cantilevered construction. The cantilevered construction of the elongate heater advantageously is supported by the frame 100 on a single end (the proximal end 144) allowing the free end (the distal end 142), to be insertable into vessels. In various embodiments, the elongate heater 140 is configured to be inserted into an opening of a vessel. Such a configuration will be described in more detail below with reference to FIG. 4 and FIG. 5.

The elongate heater 140 has a cantilevered beam 141 and a first heater element 151. In various embodiments, the elongate heater 140 has a plurality of heater elements 150 coupled to the cantilevered beam 141, where the plurality of heater elements 150 includes the first heater element 151. The elongate heater 140 defines an elongate axis A140. The elongate axis A140 extends along the length of the elongate heater 140. The elongate axis A140 is generally extends centrally to the cantilevered beam, along the length of the cantilevered beam 141. The elongate axis A140 can be a straight line. Each heater element 150 is coupled to the cantilevered beam 141. The cantilevered beam 141 can be constructed from a variety of materials and combinations of materials. In various embodiments the cantilevered beam 141 can be constructed of a non-porous material such as stainless steel. Such a configuration may advantageously reduce the opportunity for the cantilevered beam 141 to harbor microbial growth. Such a configuration may advantageously facilitate cleaning and other maintenance of the cantilevered beam 141. The cantilevered beam 141 can be constructed of a single segment of pipe or beam or multiple segments of pipes or beams that are coupled in series to define the elongate length of the cantilevered beam 141. The cantilevered beam 141 can be a straight, linear beam.

Each heater element 150 is generally configured to produce and radiate heat. The term “heater element” is used herein to refer to any heat source. Types of heater elements include but are not limited to short wave infrared, medium wave infrared, long wave infrared, halogen, radio frequency, microwave, ultrasonic and quartz heater elements. In some embodiments, all of the plurality of heater elements 150 can be the same type of heater element. In some embodiments, combinations of heater element types can be used in the plurality of heater elements. In some embodiments where there is a single heater element, such as the first heater element 151, the first heater element 151 can have an elongate structure having an elongate length that runs parallel to and along the length of the cantilevered beam 141.

In various embodiments, the intensity of the heat radiating from each heater element 150 is adjustable by a user. Each heater element 150 (including examples where there is a single heater element such as the first heater element 151) can have a controller accessible by a user. In some embodiments each of the heater elements 150 are independently controllable by a user. In some other embodiments the heater elements 150 are collectively controllable by a user such that adjustment of the radiation intensity occurs across all of the heater elements 150. The controls used to operate and adjust the heater elements 150 can be on each heater element 150 itself or can be located in a control box 132 (FIG. 1A) coupled to the frame 100 that is selectively accessible by the user. In the latter example, the control box 132 houses the adjustment controllers that are in operative communication with each heater element 150.

Additional radiation elements (not currently depicted) configured to radiate other types of electromagnetic radiation can be used in combination with heater elements 150. Such electromagnetic radiation can be configured to inhibit or kill microbes, which is discussed in more detail, below. Types of electromagnetic radiation elements include radio wave, microwave, visible light, ultraviolet (UV), x-ray, or gamma ray radiation. Each of the additional elements are generally coupled to the cantilevered beam 141. In some embodiments, the plurality of heater elements 150 can alternate with the additional radiation elements along the length of the cantilevered beam 141. Various combinations of heater elements 150 and additional radiation elements may be used. In one example, a plurality of infrared heater elements 150 and a plurality of ultraviolet additional radiation elements are coupled to the cantilevered beam 141.

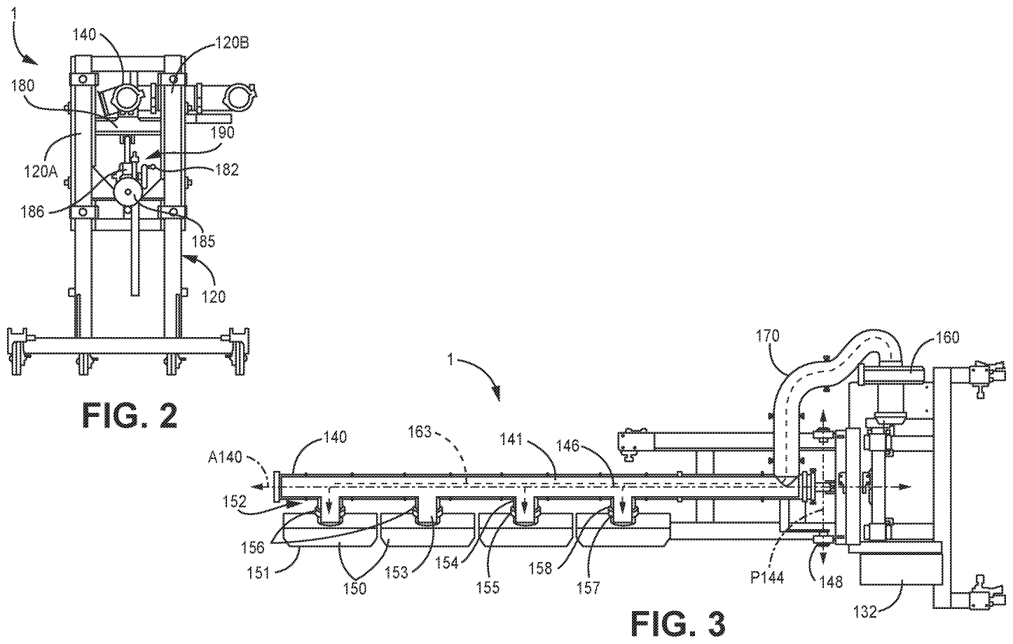

Each heater element 150 is coupled to the cantilevered beam 141 of the elongate heater 140 through a connection point 152. Each connection point 152 can have a variety of configurations. Alternative configurations of example connection points 152 are visible in FIGS. 1B and 3. In the exemplary embodiments depicted, there are four heater elements 150. Each of the four heater elements 150 are coupled to the cantilevered beam 141 through a separate connection point 152. In some embodiments, the configuration of connection point 152 includes a mounting brace 156. The mounting brace 156 is configured to couple each heater element 150 to the cantilevered beam 141. In some embodiments, the mounting brace 156 is configured to facilitate detachment and reattachment of the heater element 150. Such a configuration may advantageously facilitate maintenance operations on the heater element 150.

Each mounting brace 156 is generally coupled to one or more heater elements 150. The mounting brace 156 can be coupled to a heater element with fasteners, for example. In some embodiments, such as that depicted in FIG. 1B, each mounting brace 156 has a first end 157 coupled to a heater element and a second end 158 disposed around the outer surface of the cantilevered beam 141. The second end 158 frictionally engages a portion of the outer surface of the cantilevered beam 141 to couple the heater element 150 to the cantilevered beam 141. In some other embodiments, such as that depicted in FIG. 3, each mounting brace 156 is coupled to a heater element 150 at a first end 157 and a portion of an extension arm 154 at the opposite end 158, where the extension arm 154 extends outwardly from the cantilevered beam 141 and is discussed in more detail below. In some embodiments, the mounting brace 156 is coupled to a distal end 155 of the extension arm 154, as depicted. In such a configuration, the mounting brace 156 can be fixed to one of the extension arms 154 or the heater element 150 and can be detachably coupled to the other of the extension arm 154 or the heater element 150 such as through fasteners, mating threads, compression fits, and the like. Components that can be used as a mounting brace 156 includes round mounting brackets, clamp-on framing and fittings, threaded collars, mounting magnets, slip fitter backets, and the like.

As mentioned above, the configuration of each of the connection points 152 can include an extension arm 154. In some embodiments the extension arm 154 is coupled to the cantilevered beam 141 and extends outward from the cantilevered beam 141. In some embodiments (such as some embodiments consistent with FIG. 1B), the extension arm 154 is coupled to the heater element 150 and is uncoupled from, but frictionally engages the outer surface of the cantilevered beam 141. The extension arm 154 can extend perpendicularly outward relative to the elongate length of the cantilevered beam 141. The extension arm 154 can be constructed from a variety of materials and combinations of materials. In various embodiments the extension arm 154 can be constructed the same material as the cantilevered beam 141. The extension arm 154 can be a separate component that is coupled to the cantilevered beam 141 or, in some embodiments, the extension arm 154 is a unitary cohesive component with the cantilevered beam 141. In examples, such as some examples consistent with FIG. 1B, the length of the cantilevered beam 141 having the extension arm 154 is a t-shaped pipe or beam that forms a portion of the length of the cantilevered beam 141.

In some embodiments, the elongate heater 140 is hollow along at least a portion of the length of the cantilevered beam 141, which forms a beam cavity 146, which is visible in FIG. 3. The beam cavity 146 may extend the entire length of the cantilevered beam 141 or only a portion of the length of the cantilevered beam 141. In some embodiments the cantilevered beam 141 has a generally tubular structure such that the beam cavity 146 is cylindrical in shape within the cantilevered beam 141. In some embodiments the beam cavity 146 is prism-shaped where the interior surface of the cantilevered beam 141 defines a prism. In some other embodiments the beam cavity 146 can have an irregular shape. The beam cavity 146 may advantageously allow the cantilevered beam 141 to be lighter in weight than a solid cantilevered beam 141. The beam cavity 146 may advantageously allow for a gas or liquid to be passed through cantilevered beam 141. For example, air may be blown through the beam cavity 146 as discussed in more detail below. The beam cavity 146 may also advantageously receive electrical wiring and other cables, such as electrical wiring extending between the heater elements 150 and a control box 132 (particularly visible in FIGS. 1A and 3).

In some embodiments, at least a portion of each extension arm 154 defines an extension cavity 153. In some embodiments, each extension cavity 153 of each connection point 152 is in airflow communication with the external environment. For example, the extension arm 154 of each connection point 152 may have an opening is direct communication with the external environment. In some embodiments, each extension cavity 153 of each connection point 152 is in airflow communication with the beam cavity 146. For example, each extension cavity 153 of each connection point 152 may have an opening exposing the extension cavity 153 to the beam cavity 146, allowing air exchange between the beam cavity 146 and the extension cavity 153. In some embodiments, each extension cavity 153 of each connection point 152 is in airflow communication with the external environment and the beam cavity 146 of the cantilevered beam 141. For example, each extension arm 154 of each connection point 152 has a first opening in direct airflow communication with the external environment and a second opening in direct airflow communication with the beam cavity 146.

In various embodiments, each extension cavity 153 and the beam cavity 146 define an airflow pathway 163 extending from the external environment to one or more locations adjacent each of the heater elements 150. In such embodiments, a blower 160 can be disposed along the airflow pathway 162. The term “blower” is used herein to refer to a device that blows air. A blower can be but is not limited to a centrifugal blower, positive displacement blower, helical screw blower, high speed blower, regenerative blower, or the like. The blower 160 can be configured to be in direct airflow communication with the beam cavity 146 of the elongate heater 140. In various embodiments, the blower 160 is configured to blow air along the airflow pathway 162. In this example, the blower 160 is configured to direct air from the external environment through the beam cavity 146 and the extension cavity 153. Such a configuration may advantageously facilitate the dispersal of heat radiating from the heater elements 150 into the surrounding environment, such as a vessel (not currently depicted; described in more detail below) within which the elongate heater 140 is positioned. Additionally, or alternatively, such a configuration may advantageously prevent overheating of heater elements 150 by dissipating heat retained by the heater elements 150.

The blower 160 is configured to be mounted on the frame 100. The blower 160 can be mounted to the frame 100 at a variety of different locations. In some embodiments, the blower 160 can be mounted anywhere on the base structure 110 or the support beam 120. In exemplary embodiments such as those depicted in FIG. 1A and FIG. 3, the blower 160 is mounted onto the first primary support beam 120A. In some embodiments, the blower 160 is mounted to the mounting structure 180. In some embodiments, the blower 160 can be mounted to the cantilevered beam 141. In some such embodiments the blower 160 can be mounted towards the proximal end 144 of the cantilevered beam 141 so as to reduce a moment arm acting on the elongate heater 140 via the blower 160. Mounting methods known in the art can be used to mount the blower 160 to the frame 100.

A tube 170 can define a portion of the airflow pathway 162 between the blower 160 and the beam cavity 146. The tube 170 is configured to allow for airflow communication between the elongate heater 140 and the blower 160. The tube 170 extends from the blower 160 to the beam cavity 146 of the elongate heater 140. The blower 160 is configured to direct air from the external environment through the tube 170 and into the beam cavity 146 and each extension cavity 153. The tube 170 can be constructed of a variety of materials and combinations of materials. In some embodiments, at least a portion of the length the tube 170 is flexible such as by being constructed of an elastomeric material and/or having concertinaed sidewalls. Such a configuration may advantageously facilitate translation of the cantilevered beam 141 (discussed in more detail below) without disrupting the airflow pathway 162. In some embodiments, at least a portion of the tube 170 is inflexible, rigid material such as a rigid length of duct or pipe.

The elongate heater 140 attachment to the support beam 120 can have a variety of different configurations. In the embodiments depicted in FIG. 1A and FIG. 1B, the configuration includes a mounting structure 180 (note the slightly different configurations of the mounting structures 180 depicted in FIGS. 1A and 1B). The mounting structure 180 is configured to support the elongate heater 140 relative to the frame 100. The mounting structure 180 is coupled to the support beam 120 of the frame 100 and, in particular, the primary support beams 120A, 120B. The mounting structure 180 extends in a generally horizontal direction outwardly from the primary support beam 120 of the frame 100. In the current example, the elongate heater 140 is mounted to a top surface of the mounting structure 180, but in other embodiments the elongate heater 140 can be mounted to another surface of the mounting structure 180 such as a bottom surface. In exemplary embodiments s shown in FIG. 1A, and FIG. 3, the mounting structure 180 has multiple beams that cumulatively define the mounting structure 180.

The elongate heater 140 is mounted to the mounting structure 180 via one or more clamps 188. At least one clamp 188 fastens the cantilevered beam 141 to the mounting structure 180. In the current examples, the clamp 188 has a first end 187 fixed to the mounting structure 180 and a shaft collar 189 extending outward from the first end 187. The shaft collar 189 defines an opening that is configured to receive the cantilevered beam 141. In an operating state, the shaft collar 189 is generally tightened to exert compression force on the outer surface of the cantilevered beam 141 to maintain the position of the cantilevered beam 141 (and the heater elements 150) relative to the elongate axis A140. In embodiments, a first clamp 188 fastens the proximal end 144 of the cantilevered beam 141 to the mounting structure 180 and a second clamp 188 fastens the cantilevered beam 141 to the mounting structure 180 between the proximal end 144 and the distal end 142 of the cantilevered beam 141.

In various embodiments, the first heater element 151 is rotatable about the elongate axis A140. In some such embodiments, the elongate heater 140 is rotatable about the elongate axis A140, while in other embodiments, each heater element 150 is rotatable about the elongate axis A140. Rotation about the elongate axis A140 allows the plurality of heater elements 150 to have a variety of orientations relative to the elongate axis A140. In some examples, the heater device 1 is configured to rotate the plurality of heater elements in unison. In some such examples, at least the length of the cantilevered beam 141 that is coupled to each of the plurality of heater elements 150 is rotatable about the elongate axis A140. Rotation of the cantilevered beam 141 incorporating shaft collars 189 described above can be achieved in some embodiments by loosening the clamp(s) 188 to reduce the compression force on the cantilevered beam 141, and then manually rotating the elongate heater 140 about the elongate axis A140 to achieve the desired orientation. The clamps 188 can then be tightened at the desired orientation. In some such embodiments a handle, knob, wheel, or other interface can be coupled to the cantilevered beam 141 to facilitate rotation of the elongate heater 140 relative to the elongate axis A140. Rotation can be accomplished manually or via automation.

Additionally, or alternatively, each of the plurality of heater elements 150 can be pivotably coupled to the cantilevered beam 141 such that each individual heater element 150 is independently rotatable about the elongate axis A140. Rotating the individual heater elements 150 independently may provide the advantage of allowing multiple heater elements 150 to have different orientations relative to the elongate axis A140 simultaneously. In one example, each heater element 150 is coupled to a discrete segment of the cantilevered beam 141, where the discrete segments are separated from adjacent segments by ring bearings that allow rotation of each of the discrete segments independently of other segments. Locking mechanisms extending across discrete segments can be configured to engage to set the orientation of one discrete segment to an adjacent discrete segment.

In yet another example, each heater element 150 is coupled to the cantilevered beam 141 with a mount that is independently rotatable about the elongate axis A140. In such embodiments, each heater element 150 is rotatably coupled to the cantilevered beam 141. For example, each heater element 150 can be coupled to a clamp that selectively compresses the cantilevered beam 141. Each clamp can be loosened to enable individual rotation of the particular heater element 150 about the cantilevered beam 141 (and, therefore, about the elongate axis A140). When the desired orientation of the individual heater element 150 is obtained, the clamp can then be tightened to fix the orientation of the heater element relative to the cantilevered beam 141 and the elongate axis A140. Such a configuration can be consistent with some examples corresponding to FIG. 1B.

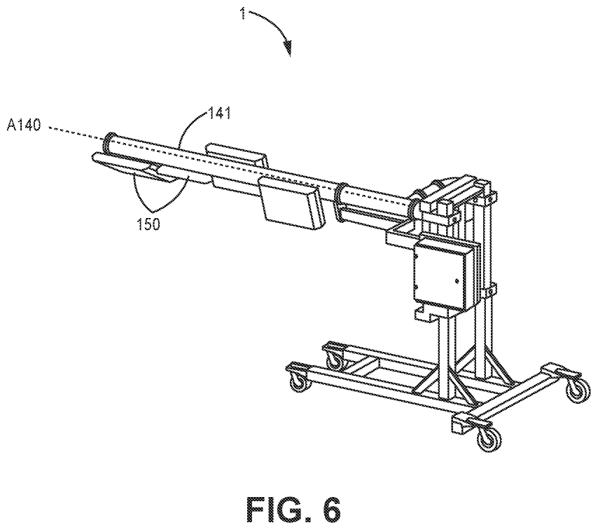

In some examples, each of the plurality of heater elements 150 can be rotatable to have a different orientation than one or more adjacent heater elements 150 relative to the elongate axis A140, an example of which is visible in FIG. 6. Heater elements are considered to have different orientations relative to the elongate axis A140 when the heater elements are positioned to emit heat in different radial directions from the elongate axis A140. In the examples of FIGS. 1A and 1B, the heater elements 150 are considered to have the same orientation relative to the elongate axis A140 because they are configured to emit heat in the same radial direction from the elongate axis.

In some embodiments, one or both of the cantilevered beam 141 and the individual heater elements 150 are not limited in rotation about the elongate axis A140. In some embodiments, the maximum rotation of the elongate heater 140, the cantilevered beam 141, and/or individual heater elements 150 about the elongate axis is 360 degrees in one or both clockwise or counterclockwise directions. In some embodiments, the maximum rotation about the elongate axis A140 of the elongate heater 140 is about 50 degrees, 40 degrees or 30 degrees in each of the clockwise and counterclockwise directions. In some embodiments, the maximum rotation about the elongate axis A140 of the elongate heater is about 15 degrees in each of the clockwise and counterclockwise directions.

In some embodiments, the orientation of each of the plurality heater elements 150 is fixed relative to the cantilevered beam 141. In some such examples, each of the plurality of heater elements 150 can be fixed to the cantilevered beam 141 to have a different orientation than an adjacent heater element relative to the elongate axis A140, such as visible in FIG. 6. In such embodiments, the heater elements can be oriented consistently with an expected region needing treatment, which will be discussed in more detail, below. In examples where the orientation of each of the plurality of heater elements 150 is fixed relative to the cantilevered beam 141, the cantilevered beam 141 is rotatable about the elongate axis A140. In some other examples where the orientation of each of the plurality of heater elements 150 is fixed relative to the cantilevered beam 141, the cantilevered beam 141 also has a fixed orientation about the elongate axis A140.

The elongate heater 140 generally has a vertical position that is modifiable relative to the base structure 110 of the frame 100. A variety of configurations can be used to achieve a modifiable vertical position of the elongate heater 140 relative to the base structure 110. In various embodiments, the heater device 1 includes a vertical translation assembly 190. In the current example, the vertical translation assembly 190 adjustably couples the primary support beam 120 to the mounting structure 180. The vertical translation assembly 190 is in mechanical communication with the mounting structure 180 and is configured to vertically translate the mounting structure 180 relative to the primary support beam 120.

In the current example the vertical translation assembly 190 has a sliding frame 192 that slidably couples the mounting structure 180 to the primary support beam 120. The mounting structure 180 extends generally horizontally outward from the sliding frame 192. The sliding frame 192 defines a sliding channel 194 that slidably receives the primary support beam 120, which allows for selectable sliding translation of the sliding frame 192 along the primary support beam 120. The sliding channel 194 generally constrains translation of the sliding frame 192 relative to the primary support beam 120 to the vertical direction. Particular to this example, a first sliding channel 194 slidably receives the first primary support beam 120A and a second sliding channel 194 slidably receives the second primary support beam 120B.

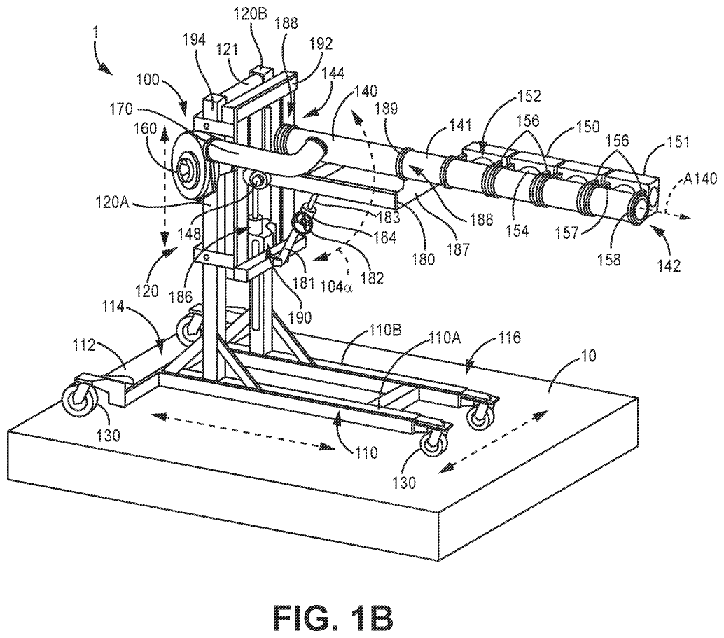

In an exemplary embodiment, the vertical translation assembly 190 has an actuator 186 (see FIGS. 1B and 2) operably disposed between the sliding frame 192 and the primary support beam 120. The actuator 186 is generally configured to actuate translation of the sliding frame 192 relative to the primary support beam 120. In various embodiments, the actuator 186 is further configured to secure the vertical position of the sliding frame 192 relative to the primary support beam 120. The actuator 186 can have a first portion coupled to one of the sliding frame 192 or the primary support beam 120, and a second portion coupled to the other of the sliding frame 192 or the primary support beam 120. In operation, the first portion translates vertically towards or away from the second portion, thereby translating the sliding frame 192 vertically along the primary support beam 120 via the sliding channels 194. In one example, the actuator 186 is a manual or automated screw jack. A variety of alternate types of actuators 186 can be used in the alternative to the screw jack including but not limited to, scissor jack, floor jack, bottle jack, high lift jack, and the like. Other actuators can include, but are not limited to, winch and pulley systems. The actuator 186 can be manually or electrically operated. In the example visible in FIG. 2 (which notably omits components such as the control box, blower, and heater elements, among others), the actuator 186 has a hand crank 185 that can be manually operated by a user to raise and lower the elongate heater 140. The vertical position of the elongate heater 140 can be secured by a mechanical locking device such as a pin that obstructs vertical translation of the sliding frame 192 and/or obstructs operation of the actuator 186.

In some embodiments the elongate axis A140 of the elongate heater 140 is substantially horizontal, meaning that the elongate axis A140 is within 5°, 3°, or 1° of horizontal, or is perfectly horizontal. In some such embodiments the angle of the elongate axis A140 relative to a horizontal plane is fixed. In some other embodiments, the elongate heater 140 is configured to be tilted relative to the horizontal plane such that the angle of the elongate axis A140 relative to the horizontal plane is adjustable. In some embodiments, the elongate heater 140 is configured to be tilted up to 15 degrees (in either a clockwise or counterclockwise direction) from a horizontal position

In some embodiments where the elongate heater 140 is configured to be tilted, the elongate heater 140 is configured to form an adjustable angle 104α with the support beam 120. A tilting device 184 (FIG. 1B) can be configured to adjust the adjustable angle 104a of the elongate axis A140 relative to the primary support beam 120. The tilting device 184 is configured to tilt the elongate heater 140 about a tilt axis P144 (visible in FIG. 3). In examples consistent with the current figures, the tilt axis P144 is defined between the mounting structure 180 and the primary support beam. More specifically, the mounting structure 180 is pivotably coupled to the sliding frame 192 along the tilt axis P144 at hinges 148. Tilting the elongate heater 140 about the tilt axis P144 defines the adjustable angle 104a between the elongate axis A140 and the primary support beam 120. In some such embodiments where the support beam 120 is vertical, the adjustable angle 104α of the elongate heater 140 ranges from 0-15 degrees from perpendicular relative to the support beam 120. The adjustable angle 104a corresponds to a particular angle of the elongate axis A140 relative to horizontal.

In an exemplary embodiment depicted in FIG. 1B the tilting device 184 couples the mounting structure 180 to the primary support beam 120. The tilting device 184 is in mechanical communication with the mounting structure 180. Adjusting the adjustable angle 104a occurs by employing the tilting device 184 which tilts the mounting structure 180 about tilt axis P144, as well as the features coupled to the mounting structure 180, such as the elongate heater 140. In particular, the tilting device 184 has a first end 181 and a second end 183 that are configured to linearly expand apart or contract together upon manual or electrical actuation by a user. The first end 181 is coupled to the sliding frame 192 and the second end 183 is coupled to the mounting structure 180. When the tilting device 184 expands, the mounting structure 180 and, therefore, the elongate heater 140, tilts upward about the tilt axis P144. When the tilting device 184 contracts, the mounting structure 180, therefore, the elongate heater 140, tilts downward about the tilt axis P144. As such, the elongate heater 140 is tilted about tilt axis P144, thereby adjusting the adjustable angle 104a between the elongate axis A140 and the primary support beam 120.

In the above example, the tilting device 184 has a manual or automated screw jack. A variety of types of actuators can be used in the tilting device 184 including but not limited to, scissor jack, floor jack, bottle jack, high lift jack, or their automated counterparts. Other devices can be used including a winch and pulley system. In the example visible in FIG. 1B, the tilting device 184 has a handwheel 182 that can be manually operated by a user to tilt the elongate heater 140 about the tilt axis P144. The tilt position of the elongate heater 140 can be secured by a mechanical locking device such as a pin that obstructs tilting of the mounting structure 180 and/or obstructs operation of the tilting device 184.

### Exemplary Embodiments of Systems

Embodiment 1. A system comprising:
a vessel having a vessel central axis, a first end, and a second end, the vessel forming a vessel cavity extending from the first end through the second end about the vessel central axis; and
a heater device having a frame and a cantilevered elongate heater extending from the frame, wherein the elongate heater is selectively insertable into the vessel cavity and removable from the vessel cavity, and wherein the elongate heater has an elongate axis that is adjustable relative to the vessel central axis.
Embodiment 2. The system of any one of embodiments 1 and 3-10, wherein the elongate heater has a modifiable vertical position relative to the frame.
Embodiment 3. The system of any one of embodiments 1-2 and 4-10, wherein the elongate heater forms an adjustable angle with the frame.
Embodiment 4. The system of any one of embodiments 1-3 and 6-10, the elongate heater comprises a plurality of heater elements disposed across the elongate heater.
Embodiment 5. The system of embodiment 4, wherein the plurality of heater elements comprise infrared heater elements.
Embodiment 6. The system of any one of embodiments 1-5 and 7-10, further comprising a blower mounted to the frame, wherein the blower is in airflow communication with the elongate heater.
Embodiment 7. The system of any one of embodiments 1-6 and 8-10, further comprising a flexible tube extending from the blower to the elongate heater.
Embodiment 8. The system of any one of embodiments 3-7 and 9-10, wherein the elongate heater is configured to be tilted up to 15 degrees from horizontal.
Embodiment 9. The system of any one of embodiments 4 and 5, wherein each of the plurality of heater elements are independently rotatable about an elongate axis central to the elongate heater.
Embodiment 10. The system of any one of embodiments 1-9, wherein the elongate heater is rotatable about an elongate axis central to the elongate heater.

### Specific Example Systems

FIG. 4 depicts a perspective view of an example system consistent with the technology disclosed herein, where the system is an example implementation of a heater device consistent with the descriptions above. FIG. 5 depicts a first view of the example system in FIG. 4. FIG. 4 and FIG. 5 can be viewed in conjunction for understanding the present description. The system 3 is generally configured to treat byproducts. The term “treat” used herein generally refers to inhibiting the reproduction of and/or killing of microbes. Treatment includes heating and drying, but also can encompass additional and alternative approaches such as exposing byproducts to electromagnetic radiation as discussed above. The term “drying” is used herein to refer to removing moisture from the referenced byproduct and should not be interpreted as limiting the particular method used to remove the moisture. “Moisture” is used herein to mean water or other liquid (such as alcohol) diffused in gas as vapor, within a solid, or condensed on a surface.

The term “byproduct” used herein generally refers to leftover material from the processing of agricultural and/or food products. Byproducts can be treated with systems described herein, and then incorporated into other products. The types of byproducts that can be treated with systems described herein include but are not limited to: spent brewers grain; soy fibers; corn stocks and silk; fruit and vegetable pulp; botanicals; carrot pomace; potato peels; orange pulp and peel; green pea peels; apple pomace; banana peels rhizomes, leaves, young stalks and pseudostems; citrus fruit waste; mango peel and kernel; grape stems, seeds, and pomace; coffee bean husks; coffee grounds; eggshells; eggshell membranes; whey; agave; and cereal grains including wheat, oat, barley and corn.

The byproducts treated with the disclosed system can be preprocessed or not preprocessed prior to treatment. Preprocessing may include washing, crushing, cutting, compressing, or mixing, as examples. In an example implementation where systems disclosed herein are used to process byproducts of egg processing, specifically eggshells and egg membrane, preprocessing can include centrifuging the byproduct to separate at least a portion of the egg membrane from the eggshells. Preprocessing can also include crushing the eggshells prior to treatment of the eggshells. In some such implementations the separated egg membrane can be used in other manufacturing processes without treatment by systems disclosed herein.

Turning to FIGS. 4 and 5, the system 3 generally has a vessel assembly 2 and a heater device 1. The heater device 1 is consistent with the discussions above. The vessel assembly 2 generally has a vessel support structure 400 and a vessel 300. The vessel 300 is generally configured to receive and contain the particular byproducts for treatment. The vessel 300 has a first end 302, a second end 304, and a central axis A300. A vessel cavity 310 extends from the first end 302 through the second end 304 about the central axis A300. In some embodiments, the vessel cavity 310 extends through both the first end 302 and the second end 304. In some embodiments, the vessel cavity 310 does not extend through both the first end 302 and the second end 304. In some embodiments, the vessel cavity extends through the second end 304 but not the first end 302.

The vessel 300 can have a variety of configurations. In some embodiments the vessel 300 is an enrobing or tumbling drum. In an exemplary embodiment depicted in FIG. 4 and FIG. 5 the vessel 300 is a drum with a tapered first end 302 and a tapered second end 304. Each of the first end 302 and the second end 304 taper inward towards the central axis A300 such that the cross dimension of the vessel 300 on each of the first end 302 and the second end 304 in the plane perpendicular to the central axis A300 decreases outwardly in the elongate direction. Such a configuration may advantageously prevent byproduct that has been received by the vessel 300 from falling out of the vessel 300.

The vessel 300 is generally configured to rotate about the vessel central axis A300. Such a configuration may advantageously facilitate agitation or mixing of the byproduct(s) and additional materials for treatment. The vessel 300 can be configured to rotate about the vessel central axis A300 continuously. The vessel 300 can be configured to rotate in the clockwise direction, the counterclockwise direction, or selectively in both of the clockwise and counterclockwise directions. In some embodiments, the vessel 300 is configured to switch its direction of rotation throughout the treatment time.

The vessel support structure 400 is generally configured to support the vessel 300 and facilitate rotation of the vessel 300 about the central axis A300. The vessel support structure 400 can have a variety of configurations. In some embodiments, bearings may be disposed between the vessel 300 and the vessel support structure 400. In some embodiments, the vessel support structure 400 may have guide rails encircling the vessel 300. In various embodiments, a motor 402 is mounted to the vessel support structure 400 that is configured to rotate the vessel 300 about the vessel central axis A300.

To aid in mixing the byproduct during vessel rotation, a plurality mixing enhancing elements 408 can be used. A “mixing enhancing element” used herein generally refers to mechanism for agitating the byproduct within the vessel cavity 310 while the vessel is rotating about the vessel central axis A300. A mixing enhancing element 408 can be a discontinuity defined by the inner surface of the vessel 300. A variety of mixing enhancing elements 408 can be used including but not limited to baffles placed in the vessel cavity 310 on the interior wall of the vessel 300. In an exemplary embodiment depicted in FIG. 4, the mixing enhancing elements 408 include sheet metal formed into blunt triangular prisms and coupled to the interior wall of the vessel cavity 310. Each of the triangular prisms are coupled to the interior wall of the vessel cavity 310. Each of the triangular prisms are spaced circumferentially around the vessel central axis A300 and extend along at least a portion of the length of the vessel cavity 310 between the first end 302 and the second end 304. In an alternative embodiment, the mixing enhancing elements are indentations in the walls of the vessel cavity 310. In some embodiments the mixing enhancing element(s) 408 are integral to the inner surface of the vessel 300.

As discussed above, the elongate heater 140 has a plurality of heater elements 150 coupled to a cantilevered beam 141. The heater device 1 is translatable across a ground surface 10 (visible in FIG. 5). The distal end 142 of the elongate heater 140 is insertable through the second end 304 of the vessel 300. Upon insertion of the elongate heater 140 into the vessel cavity 310, at least a portion of the plurality of heater elements 150 are positioned in the vessel cavity 310. The cantilever configuration of the elongate heater 140 may advantageously allow the elongate heater 140 to be inserted into the vessel 300 with reduced interference between the heater device 1 and the vessel assembly 2.

The system 3 is generally configured such that the elongate axis A140 can be adjusted relative to the vessel central axis A300. In various embodiments, adjustment of the elongate axis A140 relative to the vessel central axis A300 can be accomplished via the tilting device 184, as described above. In some embodiments, adjustment of the elongate axis A140 relative to the vessel central axis A300 can be accomplished via translation of the heater device 1 along the ground surface 10 relative to vessel 300. For example, the translation of at least a portion of the elongate heater 140 horizontally along the ground surface 10 in the elongate direction into or out of the vessel cavity 310. In some embodiments, adjustment of the elongate axis A140 relative to the vessel central axis A300 can be accomplished via translation of the heater device 1 horizontally along the ground surface 10 in the lateral direction, where the lateral direction is perpendicular to the elongate direction. Furthermore, as discussed above, the elongate heater 140 can be translated vertically such that the elongate axis A140 can be adjusted vertically relative to the vessel axis A300. Vertical adjustment of the elongate axis A140 relative to the vessel central axis A300 can be accomplished via the vertical translation assembly 190, which has been discussed in detail, above.

### Exemplary Embodiments of Methods

Embodiment 1. A method of treating a byproduct comprising:
loading a byproduct into a vessel cavity of a vessel;
rotating the vessel about a central vessel axis;
inserting an elongate heater of a heater device into a vessel cavity of the vessel;
radiating heat at an intensity from the elongate heater into the vessel cavity; and
changing the intensity of the heat radiating from the elongate heater.
Embodiment 2. The method of any one of embodiments 1 and 3-7, further comprising adjusting an elongate axis of the elongate heater relative to the vessel central axis.
Embodiment 3. The method of embodiment 2, wherein adjusting the elongate axis comprises tilting the elongate axis relative to the vessel central axis.
Embodiment 4. The method of any one of embodiments 2 or 3, wherein adjusting the elongate axis comprises translating the elongate axis vertically relative to the vessel central axis.
Embodiment 5. The method of any one of embodiments 1-4 and 6-7, wherein the heater device is an infrared heater device.
Embodiment 6. The method of any one of embodiments 1-5 and 7, wherein the byproduct comprises grain.
Embodiment 7. The method of any one of embodiments 1-6, wherein the byproduct comprises eggshells.

### Specific Example Methods

In an exemplary method for using heating system 3 for treating byproducts, the byproduct is loaded into the vessel cavity 310 of the vessel 300. The byproduct can be consistent with byproducts discussed above. The vessel 300 is rotated about the central vessel axis A300 causing agitation of the byproduct within the vessel cavity 310. The elongate heater 140 of the heater device 1 is inserted into a vessel cavity 310 of the vessel 300. Heat is radiated from the elongate heater 140 at a particular intensity. The intensity of the heat radiating from the heater is changed during the treatment time.

The elongate heater 140 can be inserted into the vessel cavity 310 before rotation or during rotation of the vessel 300 about the central vessel axis A300. By inserting the elongate heater 140 into the vessel cavity 310, at least a portion of the plurality of heater elements 150 coupled to the elongate heater 140 are inserted into the vessel cavity 310. As such, the heat radiating each of the heater elements 150 is directed into the vessel cavity 310.

The intensity of the heater elements 150 can be changed throughout the treatment process. For example, the intensity of the heat radiating from the heater elements 150 can be relatively high at the beginning of the treatment process when the liquid content of the byproduct is relatively high. As the liquid content of the product is lowered, the intensity of the heat radiating from the heater elements 150 can be lowered by a user to remove the remaining liquid while reducing the likelihood that the byproduct is burned by exposing the byproduct to excess heat.

The length of treatment time, rotation rate of the vessel 300, and the intensity of the radiated heat are treatment parameters that are dependent on the particular byproduct being treated and the desired output of the treatment. With regard to the particular byproduct being treated, the radiation/heat absorptivity of the byproduct, the initial moisture content of the byproduct, and the maximum acceptable final moisture content of the byproduct are each relevant to the various treatment parameters used. Radiation/heat absorptivity of the byproduct is impacted by factors including the density, moisture absorptivity of the constituents of the byproduct, size and shape of the particles, and color.

In some methods of treatment, the heater axis A140 of the elongate heater 140 is adjusted relative to the vessel central axis A300. For example, the elongate heater 140 can be shifted in the vertical direction or the horizontal direction, as described above, thereby adjusting the heater axis A140 relative to the vessel central axis A300. As another example, the elongate heater 140 can be tilted around a tilt axis via a tilting device 184 as discussed above, which results in tilting of the heater axis A140 relative to the vessel central axis A300.

In some embodiments, during the treatment process, the elongate heater 140 of the system 3 is rotated about the elongate axis A140 to change the orientation of one or more of the heater elements 150 relative to the elongate axis A140. Rotation of the elongate heater 140 about the elongate axis A140 has been discussed in detail above. In some implementations discussed above, the elongate heater 140 has a plurality of heater elements 150 each having different fixed orientation than an adjacent heater element relative to the elongate axis A140. The orientation of each heater element 150 can be fixed such that the expected location of byproducts within the vessel is exposed to emitted heat from the particular heater element 150.

For example, in some implementations the vessel 300 is configured such that byproducts are introduced into an insertion end of the vessel 300 and progress towards the opposite end of the vessel 300 over the treatment cycle. When the byproducts are introduced into the vessel 300 they may be relatively wet and, as such, may travel higher up the interior wall of the rotating vessel 300 compared to relatively drier byproducts that have progressed closer to the opposite end of the rotating vessel 300. As such, the heater elements 150 positioned towards one end of the elongate heater 140 (that is configured to be positioned towards the insertion end of the vessel 300) may be oriented to emit heat vertically above heater elements 150 positioned towards an opposite end of the elongate heater 140 (that is configured to be positioned towards the opposite end of the vessel 300).

It should also be noted that, as used in this specification and the appended claims, the phrase “configured” describes a system, apparatus, or other structure that is constructed to perform a particular task or adopt a particular configuration. The phrase “configured” can be used interchangeably with other similar phrases such as “arranged”, “arranged and configured”, “constructed and arranged”, “constructed”, “manufactured and arranged”, and the like.

All publications and patent applications in this specification are indicative of the level of ordinary skill in the art to which the present technology pertains. All publications and patent applications are herein incorporated by reference to the same extent as if each individual publication or patent application was specifically and individually indicated by reference.

This application is intended to cover adaptations or variations of the present subject matter. It is to be understood that the above description is intended to be illustrative, and not restrictive.

1. A heater device comprising:
a frame having a base structure and a support beam extending upward from the base structure, wherein the frame is translatable across a ground surface; and
a cantilevered elongate heater extending from the frame, the elongate heater having a proximal end and a distal end, wherein the proximal end is coupled to the support beam of the frame, and wherein the elongate heater comprises a first heater element rotatable about an elongate axis central to the elongate heater.

2. The heater device of claim 1, wherein the elongate heater has a modifiable vertical position relative to the base structure of the frame.

3. The heater device of claim 1, wherein the elongate heater forms an adjustable angle with the support beam.

4. The heater device of claim 1, wherein the elongate heater comprises a plurality of heater elements disposed across the elongate heater, wherein the plurality of heater elements comprises the first heater element.

5. The heater device of claim 4, wherein the plurality of heater elements comprises infrared heater elements.

6. The heater device of claim 1, further comprising a blower mounted to the frame, wherein the blower is in airflow communication with the elongate heater.

7. The heater device of claim 6, further comprising flexible tubing extending from the blower to the elongate heater.

8. The heater device of claim 3 wherein the elongate heater is configured to be tilted up to 15 degrees from horizontal.

9. The heater device of claim 1, wherein the elongate heater comprises a cantilevered beam that is rotatable about the elongate axis.

10. The heater device of claim 4, wherein each of the plurality of heater elements are independently rotatable about the elongate axis.

11. A heater device comprising:
a frame having a base structure and a support beam extending upward from the base structure, wherein the frame is translatable across a ground surface; and
a cantilevered elongate heater extending from the frame, the elongate heater having a proximal end and a distal end, wherein the proximal end is coupled to the support beam of the frame, and wherein the elongate heater comprises a cantilevered beam having an elongate central axis and a plurality of heater elements coupled to the cantilevered beam.

12-20. (canceled)

21. A system comprising:
a vessel having a vessel central axis, a first end, and a second end, the vessel forming a vessel cavity extending from the first end through the second end about the vessel central axis; and
a heater device having a frame and a cantilevered elongate heater extending from the frame, wherein the elongate heater is selectively insertable into the vessel cavity and removable from the vessel cavity, and wherein the elongate heater has an elongate axis that is adjustable relative to the vessel central axis.

22. The system of claim 21, wherein the elongate heater has a modifiable vertical position relative to the frame.

23. The system of claim 21, wherein the elongate heater forms an adjustable angle with the frame.

24. The system of claim 21, the elongate heater comprises a plurality of heater elements disposed across the elongate heater.

25. The system of claim 24, wherein the plurality of heater elements comprise infrared heater elements.

26. The system of claim 21, further comprising a blower mounted to the frame, wherein the blower is in airflow communication with the elongate heater.

27. The system of claim 26, further comprising a flexible tube extending from the blower to the elongate heater.

28. The system of claim 23, wherein the elongate heater is configured to be tilted up to 15 degrees from horizontal.

29. The system of claim 24, wherein each of the plurality of heater elements are independently rotatable about an elongate axis central to the elongate heater.

30-37. (canceled)
